(19) United States
(12) Patent Application Publication
(10) Pub. No.: US 2021/0241198 A1
(43) Pub. Date: Aug. 5, 2021

(54) TECHNIQUES FOR ASSIGNING TASKS IN A TASK ASSIGNMENT SYSTEM WITH AN EXTERNAL PAIRING SYSTEM

(71) Applicant: Afiniti, Ltd., Hamilton (BM)

(72) Inventors: Ain CHISHTY, Rockville, MD (US); Hassan AFZAL, Bethesda, MD (US); Zia CHISHTI, Washington, DC (US)

(73) Assignee: Afiniti, Ltd., Hamilton (BM)

(21) Appl. No.: 17/169,059

(22) Filed: Feb. 5, 2021

Related U.S. Application Data
(60) Provisional application No. 62/970,533, filed on Feb. 5, 2020.

(51) Int. Cl. G06Q 10/06; H04M 3/523

(52) U.S. Cl. CPC G06Q 10/06316; H04M 3/5232; G06Q 10/063112; G06Q 10/06395

(57) ABSTRACT

Techniques for assigning tasks in a task assignment system with an external pairing system are disclosed. In one particular embodiment, the techniques may be realized as a method for assigning tasks in a task assignment system with an external pairing system comprising transmitting, by the task assignment system, to the external pairing system, a plurality of task pairing requests and an agent pairing request, wherein each task pairing request in the plurality of task pairing requests indicates a task that is received for pairing and each task pairing request in the plurality of task pairing requests indicates an agent that is available for pairing. The method may further comprise receiving, at the task assignment system, from the external pairing system, a pairing recommendation, the pairing recommendation being based at least in part on the plurality of task pairing requests and the agent pairing request.

### CROSS-REFERENCE TO RELATED APPLICATIONS

This patent application claims priority to U.S. Provisional Patent Application No. 62/970,533, filed Feb. 5, 2020, which is hereby incorporated by reference herein in its entirety.

### FIELD OF THE DISCLOSURE

The present disclosure generally relates to task assignment systems and, more particularly, to techniques for assigning tasks in a task assignment system with an external pairing system.

### BACKGROUND OF THE DISCLOSURE

A typical pairing system algorithmically assigns tasks arriving at a task assignment system to agents available to handle those tasks. At times, the task assignment system may be in an “L1 state” and have agents available and waiting for assignment to tasks. At other times, the task assignment system may be in an “L2 state” and have tasks waiting in one or more queues for an agent to become available for assignment. At yet other times, the task assignment system may be in an “L3” state and have multiple agents available and multiple tasks waiting for assignment.

Some traditional pairing systems assign tasks to agents ordered based on time of arrival, and agents receive tasks ordered based on the time when those agents became available. This strategy may be referred to as a “first-in, first-out,” “FIFO,” or “round-robin” strategy. For example, in an L2 environment, when an agent becomes available, the task at the head of the queue would be selected for assignment to the agent.

Some task assignment systems prioritize some types of tasks ahead of other types of tasks. For example, some tasks may be high-priority tasks, while other tasks are low-priority tasks. Under a FIFO strategy, high-priority tasks will be assigned ahead of low-priority tasks.

Other traditional pairing systems may implement a performance-based routing (PBR) strategy for prioritizing higher-performing agents for task assignment. Under PBR, for example, the highest-performing agent among available agents receives the next available task.

Choice-based pairing strategies (such as “Behavioral Pairing” or “BP” strategies), for assigning tasks to agents, improve upon traditional pairing methods. BP targets balanced utilization of agents while simultaneously improving overall task assignment system performance potentially beyond what FIFO or PBR methods will achieve in practice. In a BP strategy operating in an L2 environment, an agent can be paired with any of the waiting tasks regardless of the position of the task in the queue, and not just the next available task.

In typical L2 environments, each task in the queue typically has an open or busy route request, so that the task is available to be paired with a free agent at any time. Maintaining multiple open or busy route requests, each corresponding to a pending task, may put a strain on the computation resources of the task assignment system. Thus, it may be understood that there may be a need for techniques for efficiently pairing tasks with agents in a task assignment system with an external pairing system that do not strain the resources of the task assignment system.

### SUMMARY OF THE DISCLOSURE

Techniques for assigning tasks in a task assignment system with an external pairing system are disclosed. In one particular embodiment, the techniques may be realized as a method for determining a pairing in a task assignment system comprising: determining, by at least one computer processor communicatively coupled to and configured to operate in the task assignment system, that a set of one or more tasks is available for pairing with a set of one or more available agents; generating, by the at least one computer processor, a pairing request based on the determining; transmitting, by the at least one computer processor, over an application programming interface, the pairing request to an external pairing system; receiving, by the at least one computer processor, over the application programming interface, a pairing response from the external pairing system based on the pairing request; and connecting, by the at least one computer processor, a set of pairings among the set of tasks and the set of agents based on the pairing response, wherein the pairing request includes information that determines a time-based ordering of the set of agents.

In accordance with other aspects of this particular embodiment, the pairing request may include information that determines a time-based ordering of the tasks.

In accordance with other aspects of this particular embodiment, the task assignment system may be a contact center system.

In accordance with other aspects of this particular embodiment, the pairing request may identify the set of one or more tasks and the set of one or more available agents.

In accordance with other aspects of this particular embodiment, the pairing request may be a non-looping request.

In another particular embodiment, the techniques may be realized as a method for determining a pairing in a task assignment system comprising: determining, by at least one computer processor communicatively coupled to and configured to operate in the task assignment system, that a set of one or more tasks is available for pairing with a set of one or more available agents; generating, by the at least one computer processor, a pairing request based on the determining; transmitting, by the at least one computer processor, over an application programming interface, the pairing request to an external pairing system; receiving, by the at least one computer processor, over the application programming interface, a pairing response from the external pairing system based on the pairing request; and connecting, by the at least one computer processor, a set of pairings among the set of tasks and the set of agents based on the pairing response, wherein the pairing request includes information that determines a time-based ordering of the set of tasks.

In accordance with other aspects of this particular embodiment, the pairing request may include information that determines a time-based ordering of the agents.

In accordance with other aspects of this particular embodiment, the task assignment system may be a contact center system.

In accordance with other aspects of this particular embodiment, the pairing request may identify the set of one or more tasks and the set of one or more available agents.

In accordance with other aspects of this particular embodiment, the pairing request may be a non-looping request.

In another particular embodiment, the techniques may be realized as a method for determining a pairing in a task assignment system comprising: determining, by at least one computer processor communicatively coupled to and configured to operate in the task assignment system, that a task is available for pairing with a plurality of available agents; generating, by the at least one computer processor, a pairing request based on the determining; transmitting, by the at least one computer processor, over an application programming interface, the pairing request to an external pairing system; receiving, by the at least one computer processor, over the application programming interface, a pairing response from the external pairing system based on the pairing request; and connecting, by the at least one computer processor, the task to an agent of the plurality of agents based on the pairing response, wherein the pairing request includes information that determines a time-based ordering of the plurality of agents.

In accordance with other aspects of this particular embodiment, the external pairing system may maintain a mirror image of a state of the task assignment system.

In accordance with other aspects of this particular embodiment, the task assignment system may be a contact center system.

In accordance with other aspects of this particular embodiment, the pairing request may identify the task and the plurality of available agents.

In accordance with other aspects of this particular embodiment, the pairing request may be a non-looping request.

In another particular embodiment, the techniques may be realized as a method for determining a pairing in a task assignment system comprising: determining, by at least one computer processor communicatively coupled to and configured to operate in the task assignment system, that a plurality of tasks is available for pairing with an available agent; generating, by the at least one computer processor, a pairing request based on the determining; transmitting, by the at least one computer processor, over an application programming interface, the pairing request to an external pairing system; receiving, by the at least one computer processor, over the application programming interface, a pairing response from the external pairing system based on the pairing request; and connecting, by the at least one computer processor, the available agent to a task of the plurality of tasks based on the pairing response, wherein the pairing request includes information that determines a time-based ordering of the plurality of tasks.

In accordance with other aspects of this particular embodiment, the external pairing system may maintain a mirror image of a state of the task assignment system.

In accordance with other aspects of this particular embodiment, the task assignment system may be a contact center system.

In accordance with other aspects of this particular embodiment, the pairing request may identify the task and the plurality of available agents.

In accordance with other aspects of this particular embodiment, the pairing request may be a non-looping request.

In another particular embodiment, the techniques may be realized as a method for assigning tasks in a task assignment system with an external pairing system comprising transmitting, by at least one computer processor communicatively coupled to and configured to operate in the task assignment system, to the external pairing system over an application programming interface, a plurality of task pairing requests and an agent pairing request, wherein each task pairing request in the plurality of task pairing requests indicates a task that is received for pairing and the agent pairing request indicates an agent that is available for pairing; and receiving, by the at least one computer processor, from the external pairing system, a pairing recommendation, the pairing recommendation being based at least in part on the plurality of task pairing requests and the agent pairing request.

In accordance with other aspects of this particular embodiment, the task assignment system may be a contact center system.

In accordance with other aspects of this particular embodiment, the plurality of task pairing requests may be transmitted to the external pairing system before the agent pairing request.

In accordance with other aspects of this particular embodiment, the pairing recommendation may pair the agent available for pairing with a task from the plurality of task pairing requests.

In accordance with other aspects of this particular embodiment, the plurality of task pairing requests, and the agent pairing request, may be non-looping requests.

In another embodiment, the techniques may be realized as a method for assigning tasks in an external pairing system communicatively coupled to a task assignment system comprising: receiving, by at least one computer processor communicatively coupled to and configured to operate in the external pairing system, from the task assignment system over an application programming interface, a plurality of task pairing requests and an agent pairing request, wherein: each task pairing request in the plurality of task pairing requests indicates a task that is received for pairing; and the agent pairing request indicates an agent that is available for pairing; and transmitting, by the at least one computer processor, to the task assignment system, a pairing recommendation, the pairing recommendation being based at least in part on the plurality of task pairing requests and the agent pairing request.

In accordance with other aspects of this particular embodiment, the task assignment system may be a contact center system.

In accordance with other aspects of this particular embodiment, the plurality of task pairing requests may be received by the external pairing system before the agent pairing request.

In accordance with other aspects of this particular embodiment, the pairing recommendation may pair the agent available for pairing with a task from the plurality of task pairing requests.

In accordance with other aspects of this particular embodiment, the plurality of task pairing requests, and the agent pairing request, may be non-looping requests.

In another particular embodiment, the techniques may be realized as a system comprising at least one computer processor communicatively coupled to and configured to operate in a task assignment system or an external pairing system, wherein the at least one computer processor is further configured to perform the steps in the above-described method.

In another particular embodiment, the techniques may be realized as an article of manufacture comprising a non-transitory processor readable medium and instructions stored on the medium, wherein the instructions are configured to be readable from the medium by at least one computer processor communicatively coupled to and configured to operate in a task assignment system or an external pairing system and thereby cause the at least one computer processor to operate so as to perform the steps in the above-described method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram of a pairing system according to embodiments of the present disclosure.

FIG. 2 shows a block diagram of a task assignment system according to embodiments of the present disclosure.

FIG. 3 shows a block diagram of a task assignment system with an external pairing system according to embodiments of the present disclosure.

FIG. 4 shows a flow diagram of a task assignment method for a task assignment system with an external pairing system according to embodiments of the present disclosure.

FIG. 5 shows a flow diagram of a task assignment method for an external pairing system communicatively coupled to a task assignment system according to embodiments of the present disclosure.

### DETAILED DESCRIPTION

A typical pairing system algorithmically assigns tasks arriving at a task assignment system to agents available to handle those tasks. At times, the task assignment system may be in an “L1 state” and have agents available and waiting for assignment to tasks. At other times, the task assignment system may be in an “L2 state” and have tasks waiting in one or more queues for an agent to become available for assignment. At yet other times, the task assignment system may be in an “L3” state and have multiple agents available and multiple tasks waiting for assignment. An example of a task assignment system is a contact center system that receives contacts (e.g., telephone calls, internet chat sessions, emails, etc.) to be assigned to agents.

Some traditional pairing systems assign tasks to agents ordered based on time of arrival, and agents receive tasks ordered based on the time when those agents became available. This strategy may be referred to as a “first-in, first-out,” “FIFO,” or “round-robin” strategy. For example, when implementing a FIFO strategy in an L2 environment, the task at the head of the queue is placed in an “open loop” or “busy-wait” state until the task is assigned to an available agent. Similarly, when an agent becomes available, the agent is placed in an “open loop” or “busy-wait” state, until the agent is assigned to a task. As there are tasks waiting in the queue, the available agent is instantaneously paired with the task at the head of the queue, and thus does not spend substantial time in the “open loop” or “busy-wait” state. Once the task at the head of the queue is connected with the available agent, the task is removed from the queue and the next task becomes the new head of the queue. The next task now remains in an “open loop” state until it is connected with the next available agent. In this example, only one task is placed in an “open loop” or “busy-wait” state at a time.

Other traditional pairing systems may implement a performance-based routing (PBR) strategy for prioritizing higher-performing agents for task assignment. Under PBR, for example, the highest-performing agent among available agents receives the next available task.

“Behavioral Pairing,” or “BP,” strategies for assigning tasks to agents improve upon traditional pairing methods. BP targets balanced utilization of agents while simultaneously improving overall task assignment system performance potentially beyond what FIFO or PBR methods will achieve in practice. This is a remarkable achievement inasmuch as BP acts on the same tasks and same agents as FIFO or PBR methods, approximately balancing the utilization of agents as FIFO provides, while improving overall task assignment system performance beyond what either FIFO or PBR provides in practice. BP improves performance by assigning agent and task pairs in a fashion that takes into consideration the assignment of potential subsequent agent and task pairs such that, when the benefits of all assignments are aggregated, they may exceed those of FIFO and PBR strategies.

Various BP strategies may be used, such as a diagonal model BP strategy or an “off-diagonal” BP strategy such as a network flow BP strategy. These task assignment strategies and others are described in detail for a contact center context in, e.g., U.S. Pat. Nos. 9,300,802; 9,781,269; 9,787,841; and 9,930,180, all of which are hereby incorporated by reference herein. BP strategies may be applied in an L1 environment (agent surplus, one task; select among multiple available/idle agents), an L2 environment (task surplus, one available/idle agent; select among multiple tasks in queue), and an L3 environment (multiple agents and multiple tasks; select among pairing permutations).

However, when applying the BP strategies in an L2 environment, the strategy puts a strain on the resources of the task assignment system. For example, in the BP strategy, an available agent may be paired with not just the task at the head of the queue, as described in traditional pairing strategy, but any of the tasks in the queue, regardless of the position of the task in the queue. To this end, each task in the queue may have open or busy route requests, waiting to be paired with the available agent. Keeping multiple “open loop” or “busy-wait” requests puts a strain on the computational resources of the task assignment system, particularly, the Automatic Call Distributor (ACD) of the task assignment system. As explained in detail below, embodiments of the present disclosure relate to techniques for a more efficient method of pairing pending tasks with available agents, especially when the task assignment system is using BP strategies in an L2 environment.

The description herein describes network elements, computers, and/or components of a system and method for pairing strategies in a task assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

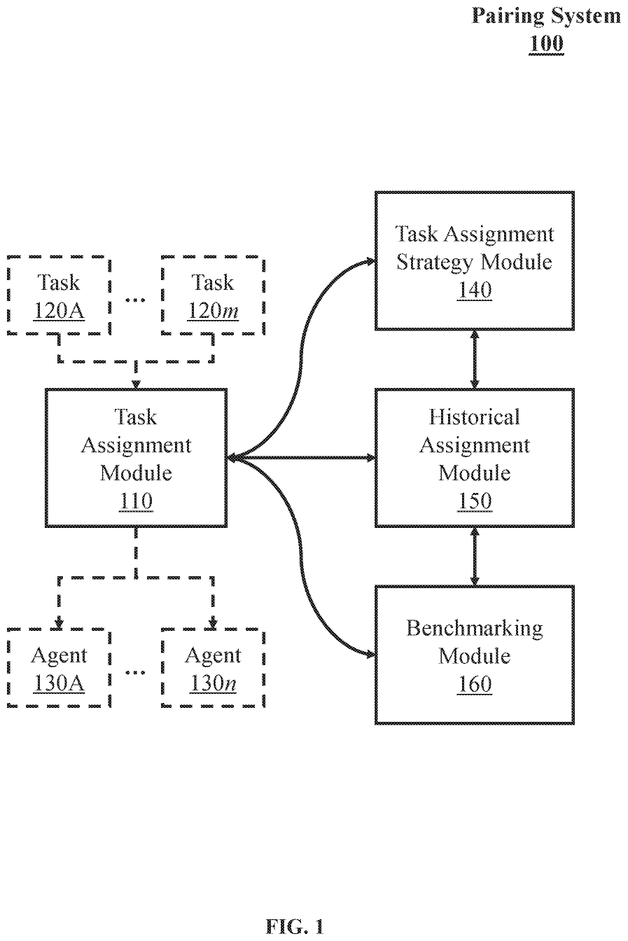

FIG. 1 shows a block diagram of a pairing system 100 according to embodiments of the present disclosure. The pairing system 100 may be included in a task assignment system (e.g., contact center system) or incorporated in a component or module (e.g., a pairing module) of a task assignment system for helping to assign tasks (e.g., contacts) among various agents.

The pairing system 100 may include a task assignment module 110 that is configured to pair (e.g., match, assign) incoming tasks to available agents. In the example of FIG. 1, m tasks 120A-120m are received over a given period, and n agents 130A-130n are available during the given period. Each of the m tasks may be assigned to one of the n agents for servicing or other types of task processing. In the example of FIG. 1, m and n may be arbitrarily large finite integers greater than or equal to one. In a real-world task assignment system, such as a contact center system, there may be dozens, hundreds, etc. of agents logged into the contact center system to interact with contacts during a shift, and the contact center system may receive dozens, hundreds, thousands, etc. of contacts (e.g., telephone calls, internet chat sessions, emails, etc.) during the shift.

In some embodiments, a task assignment strategy module 140 may be communicatively coupled to and/or configured to operate in the pairing system 100. The task assignment strategy module 140 may implement one or more task assignment strategies (or “pairing strategies”) for assigning individual tasks to individual agents (e.g., pairing contacts with contact center agents). A variety of different task assignment strategies may be devised and implemented by the task assignment strategy module 140. In some embodiments, a FIFO strategy may be implemented in which, for example, the longest-waiting agent receives the next available task (in L1 environments) or the longest-waiting task is assigned to the next available agent (in L2 environments). In other embodiments, a PBR strategy for prioritizing higher-performing agents for task assignment may be implemented. Under PBR, for example, the highest-performing agent among available agents receives the next available task. In yet other embodiments, a BP strategy may be used for optimally assigning tasks to agents using information about either tasks or agents, or both. Various BP strategies may be used, such as a diagonal model BP strategy or an off-diagonal BP strategy such as a network flow BP strategy. See U.S. Pat. Nos. 9,300,802; 9,781,269; 9,787,841; and 9,930,180.

In some embodiments, a historical assignment module 150 may be communicatively coupled to and/or configured to operate in the pairing system 100 via other modules such as the task assignment module 110 and/or the task assignment strategy module 140. The historical assignment module 150 may be responsible for various functions such as monitoring, storing, retrieving, and/or outputting information about task-agent assignments that have already been made. For example, the historical assignment module 150 may monitor the task assignment module 110 to collect information about task assignments in a given period. Each record of a historical task assignment may include information such as an agent identifier, a task or task type identifier, offer or offer set identifier, outcome information, or a pairing strategy identifier (i.e., an identifier indicating whether a task assignment was made using a BP strategy, or some other pairing strategy such as a FIFO or PBR pairing strategy).

In some embodiments and for some contexts, additional information may be stored. For example, in a call center context, the historical assignment module 150 may also store information about the time a call started, the time a call ended, the phone number dialed, and the caller's phone number. For another example, in a dispatch center (e.g., “truck roll”) context, the historical assignment module 150 may also store information about the time a driver (i.e., field agent) departs from the dispatch center, the route recommended, the route taken, the estimated travel time, the actual travel time, the amount of time spent at the customer site handling the customer's task, etc.

In some embodiments, the historical assignment module 150 may generate a pairing model or a similar computer processor-generated model based on a set of historical assignments for a period of time (e.g., the past week, the past month, the past year, etc.), which may be used by the task assignment strategy module 140 to make task assignment recommendations or instructions to the task assignment module 110.

In some embodiments, a benchmarking module 160 may be communicatively coupled to and/or configured to operate in the pairing system 100 via other modules such as the task assignment module 110 and/or the historical assignment module 150. The benchmarking module 160 may benchmark the relative performance of two or more pairing strategies (e.g., FIFO, PBR, BP, etc.) using historical assignment information, which may be received from, for example, the historical assignment module 150. In some embodiments, the benchmarking module 160 may perform other functions, such as establishing a benchmarking schedule for cycling among various pairing strategies, tracking cohorts (e.g., base and measurement groups of historical assignments), etc. Benchmarking is described in detail for the contact center context in, e.g., U.S. Pat. No. 9,712,676, which is hereby incorporated by reference herein.

In some embodiments, the benchmarking module 160 may output or otherwise report or use the relative performance measurements. The relative performance measurements may be used to assess the quality of a pairing strategy to determine, for example, whether a different pairing strategy (or a different pairing model) should be used, or to measure the overall performance (or performance gain) that was achieved within the task assignment system while it was optimized or otherwise configured to use one pairing strategy instead of another.

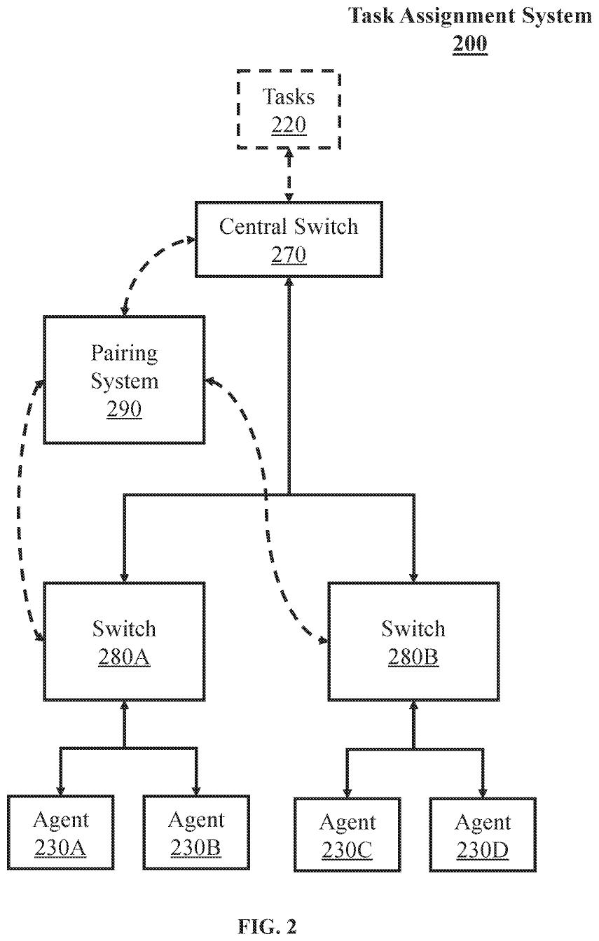

FIG. 2 shows a block diagram of a task assignment system 200 according to embodiments of the present disclosure. The task assignment system 200 may include a central switch 270. The central switch 270 may receive incoming tasks 220 (e.g., telephone calls, internet chat sessions, emails, etc.) or support outbound connections to contacts via a dialer, a telecommunications network, or other modules (not shown). The central switch 270 may include routing hardware and software for helping to route tasks among one or more queues (or subcenters), or to one or more Private Branch Exchange (“PBX”) or Automatic Call Distribution (ACD) routing components or other queuing or switching components within the task assignment system 200. The central switch 270 may not be necessary if there is only one queue (or subcenter), or if there is only one PBX or ACD routing component in the task assignment system 200.

If more than one queue (or subcenter) is part of the task assignment system 200, each queue may include at least one switch (e.g., switches 280A and 280B). The switches 280A and 280B may be communicatively coupled to the central switch 270. Each switch for each queue may be communicatively coupled to a plurality (or “pool”) of agents. Each switch may support a certain number of agents (or “seats”) to be logged in at one time. At any given time, a logged-in agent may be available and waiting to be connected to a task, or the logged-in agent may be unavailable for any of a number of reasons, such as being connected to another task, performing certain post-call functions such as logging information about the call, or taking a break. In the example of FIG. 2, the central switch 270 routes tasks to one of two queues via switch 280A and switch 280B, respectively. Each of the switches 280A and 280B are shown with two agents each. Agents 230A and 230B may be logged into switch 280A, and agents 230C and 230D may be logged into switch 280B.

The task assignment system 200 may also be communicatively coupled to an integrated pairing system 290. The pairing system 290 may be native to (or built in) the task assignment system 200 (i.e., “first-party”) or may be a service provided by, for example, a third-party vendor. In the example of FIG. 2, the pairing system 290 may be communicatively coupled to one or more switches in the switch system of the task assignment system 200, such as central switch 270, switch 280A, and switch 280B. In some embodiments, switches of the task assignment system 200 may be communicatively coupled to multiple pairing systems. In some embodiments, the pairing system 290 may be embedded within a component of the task assignment system 200 (e.g., embedded in or otherwise integrated with a switch). An example of the pairing system 290 is the pairing system 100, which is described above.

The pairing system 290 may receive information from a switch (e.g., switch 280A) about agents logged into the switch (e.g., agents 230A and 230B) and about incoming tasks 220 via another switch (e.g., central switch 270) or, in some embodiments, from a network (e.g., the Internet or a telecommunications network) (not shown). The pairing system 290 may process this information to determine which tasks should be paired (e.g., matched, assigned, distributed, routed) with which agents.

For example, in an L1 state, multiple agents may be available and waiting for connection to a task, and a task arrives at the task assignment system 200 via a network or the central switch 270. As explained above, without the pairing system 290, a switch will typically automatically distribute the new task to whichever available agent has been waiting the longest amount of time for an agent under a FIFO strategy, or whichever available agent has been determined to be the highest-performing agent under a PBR strategy. With the pairing system 290, contacts and agents may be given scores (e.g., percentiles or percentile ranges/bandwidths) according to a pairing model or other artificial intelligence data model, so that a task may be matched, paired, or otherwise connected to a preferred agent.

In an L2 state, multiple tasks are available and waiting for connection to an agent, and an agent becomes available. These tasks may be queued in a switch such as a PBX or ACD device. Without the pairing system 290, a switch will typically connect the newly available agent to whichever task has been waiting on hold in the queue for the longest amount of time as in a FIFO strategy or a PBR strategy when agent choice is not available. In some task assignment systems, priority queuing may also be incorporated, as previously explained. For example, in traditional implementations of a FIFO strategy in an L2 environment, the task at the head of the queue is placed in an “open loop” or “busy-wait” state until the task is assigned to an available agent. A task at the head of the queue may spend a considerable amount of time in this state, spending resources of the task assignment system. When an agent becomes available, the agent is placed in an “open loop” or “busy-wait” state, until the agent is assigned to a task. As in L2 environments, there is always a task in an “open loop” or “busy-wait” state at the head of the queue, the available agent is almost instantaneously paired with the task at the head of the queue, and thus does not spend substantial time in the “open loop” or “busy-wait” state. Once the task at the head of the queue is connected to the available agent, the task is removed from the queue and the next task becomes the new head of the queue. The next task now remains in an “open loop” state until it is connected to the next available agent.

With the pairing system 290 in this L2 scenario, as in the L1 state described above, tasks and agents may be given percentiles (or percentile ranges/bandwidths, etc.) according to, for example, a model, such as an artificial intelligence model, so that an agent becoming available may be matched, paired, or otherwise connected to a preferred task.

However, in a task assignment system with an external pairing system, assigning tasks may not be as straightforward. For example, in the BP strategy, an available agent may be paired with not just the task at the head of the queue, as described in traditional pairing strategy, but any of the tasks in the queue, regardless of the position of the task in the queue. To this end, each task in the queue may have open or busy route requests, waiting to be paired with the available agent. Keeping multiple “open loop” or “busy-wait” requests puts a strain on the computational resources of the task assignment system, particularly, the Automatic Call Distributor (ACD) of the task assignment system. In some embodiments, instead of maintaining each available task in an “open loop” or “busy-wait” state”, the pairing system 290 may keep a record of each of the tasks that are still pending. In some embodiments, the central switch 270 may generate and share an event with the pairing system 290 each time a task 220 is received at the central switch 270. Similarly, the switches 280A and 280B may generate and share an event with the pairing system 290 when one of the agents 230A, 230B, 230C, and 230D become available. On receiving the event signaling an available agent, the pairing system 290 may match one of the many pending tasks with the available agent indicated by the event. Because the pairing system 290 keeps track of the tasks 220 that are pending, there is no need for the task assignment system 200 to keep all the tasks 220 in an “open loop” or “busy-wait” state for the BP strategy. This embodiment of operating the BP strategy in an L2 environment does not tax the computational resources of the task assignment system 200.

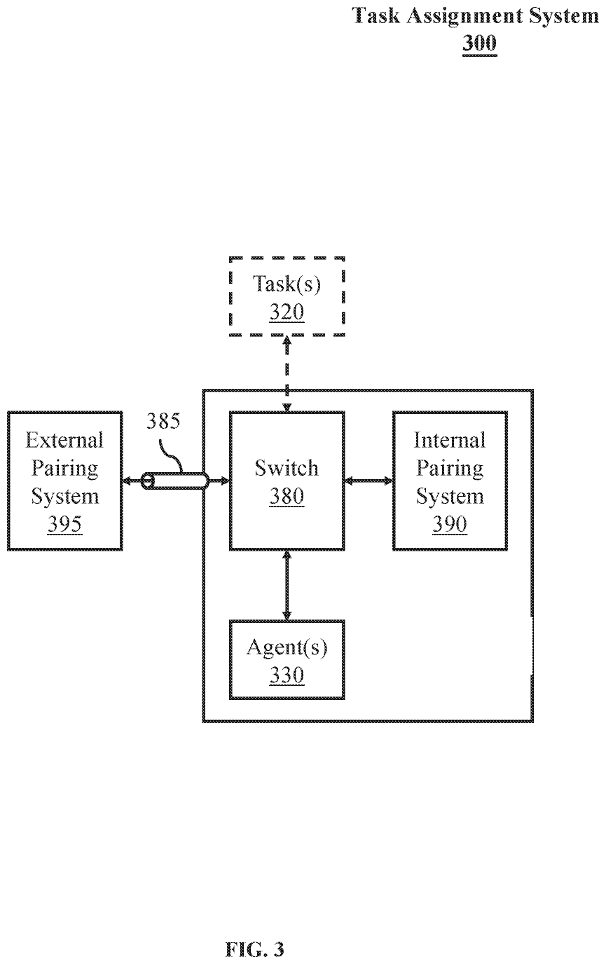

FIG. 3 shows a block diagram of a task assignment system 300 with an external pairing system 395 according to embodiments of the present disclosure. In the task assignment system 300, a switch 380 may route a plurality of tasks 320 to a plurality of agents 330. The switch 380 may include routing hardware and software, or to one or more PBX or ACD routing components or other queuing or switching components for helping to route the plurality of tasks 320 among the plurality of agents 330.

In the task assignment system 300, an internal pairing system 390 may be communicatively coupled to the switch 380. The internal pairing system 390 may be native to (or built in) the task assignment system 300 (i.e., “first-party”) or may be provided by a third-party vendor. Typically, the internal pairing system 390 may implement traditional pairing strategies (e.g., FIFO or PBR) or some other pairing strategy that may be proprietary to the task assignment system 300. However, the internal pairing system 300 may also be in the form of the pairing system 100. The internal pairing system 390 may receive or otherwise retrieve information from the switch 380 about the agents 330 logged into the switch 380 and about the incoming tasks 320.

In the task assignment system 300, the external pairing system 395 may be communicatively coupled to the switch 380 via an interface 385. The interface 385 may isolate the task assignment system 300 from the external pairing system 395 (e.g., for security purposes), and control information exchanged between the two systems. An example of the interface 385 may be a public or a private proprietary application programming interface (API) provided over a network (e.g., the Internet or a telecommunications network) (not shown).

Unlike the internal pairing system 390, the external pairing system 395 may only have access to information that is selected and shared by the switch 380. Such information must be sufficient for the external pairing system 395 to determine the optimal task-agent pairing. The external pairing system 395 may be provided by a third-party vendor and may be in the form of the pairing system 100 described above. Importantly, the external pairing system 395 may provide a pairing strategy (e.g., BP) that improves the performance of the task assignment system 300 when compared to the pairing strategy (or strategies) of the internal pairing system 390.

In some embodiments, when operating the BP strategy in an L2 environment, as described with respect to FIG. 3, switch 380 may generate and share an event with the external pairing system 395 each time a task 320 is received at the switch 380. On receiving the events from switch 380, the external pairing system 395 may store a record of the received events, thereby keeping track of tasks 320 that are received and pending. Similarly, the central switch 380 may generate and share an event with the external pairing system 395 when one of the agents 330 becomes available. In some embodiments, multiple tasks 320 may be received before an agent 330 is available to be paired with one of the tasks. When an agent 330 is available, the external pairing system 395 may match the agent 330 with one of the many tasks 320 that are recorded at the external pairing system 395 as pending.

Because the external pairing system 395 keeps track of the tasks 320 that are pending, there is no need for the task assignment system 300 to keep the tasks 320 in an “open loop” or “busy-wait” state. Accordingly, the events shared with the external pairing system 395 by the switch 380 can be non-looping. This embodiment of operating the BP strategy in an L2 environment does not tax the computational resources of the task assignment system 300. In contrast to the effectiveness of the disclosed task assignment system 300, a conventional ACD must spend processing power and memory allocation to constantly update task statuses; this demand on processing power and memory allocation increases with the number of pending tasks and causes performance bottlenecks when the demands on the conventional ACD outpace the available resources. Accordingly, the disclosed embodiment eliminates performance bottlenecks in the switch 380. Additionally, the embodiments of the present disclosure allow the task assignment system 300 more computational resources, which can be used to manage a greater number of tasks 320. This further provides a task assignment system 300 with greater throughput and capacity than conventional ACDs.

Moreover, with adequate throughput and capacity as compared with convention ACDs, the need for multiple ACDs within a contact center system and the need for a load-balancing layer to manage the load of multiple ACDs within the contact center system may be reduced or even eliminated.

In some embodiments, when operating in an L1 environment, where there are multiple available agents waiting for an available task, central switch 380 may generate and share an event with the external pairing system 395 each time an agent 330 becomes available. Central switch 380 may generate and share an event with the external pairing system 395 when a task 320 becomes available. In the L1 environment, multiple agents 320 may be available before a task 330 is available to be paired with one of the available agents 330. When a task 320 is available, the external pairing system 395 may match the task 320 with one of the many agents 330.

The external pairing system 395 may also provide the same or a similar pairing strategy as that of the internal pairing system 390. The task assignment system 300 may operate under a shared control, in which the switch 380 may send route requests alternately between the internal pairing system 390 and the external pairing system 395 to determine which task is to be routed to which agent. The shared control may be desirable, for example, when the internal pairing system 390 employs a traditional or proprietary pairing strategy (e.g., FIFO or PBR) that may not be provided by the external pairing system 395, while the external pairing system 395 is used to provide a higher-performing pairing strategy (e.g., BP).

When the external pairing system 395 includes the same or a similar pairing strategy as that of the internal pairing system 390, the task assignment system 300 may operate under full control such that the switch 380 sends all route requests to the external pairing system 395. In other words, the external pairing system 395 has full control on determining every task-agent pairing. Accordingly, the route requests from the switch 380 can be non-looping requests. Under the full control, at times, the external pairing system 395 may simulate/mimic the pairing strategy of the internal pairing system 390 (e.g., FIFO or PBR) and, at other times, employ a different pairing strategy (e.g., BP), and send its pairing recommendation to the switch 380 over the interface 385. The switch 380 may then assign the tasks 320 to agents 330 based on the pairing recommendation.

In some embodiments, the external pairing system operates in a “stateless” environment, where the task assignment system 300 may provide enough information within each route request for the external pairing system 395 to make a pairing recommendation. For example, in addition to the control flag (indicating shared control or full control) and the benchmark flag (indicating ON tasks, OFF tasks, Default, or Monitor Mode), the task assignment system 300 may provide the external pairing system 395 with an adequate amount of state information within the route request (e.g., the complete set of agents available for pairing and the complete set of tasks available for pairing). In some embodiments, the stateless route request may include additional information, such as an ordered set of agents ordered by idle time and/or an ordered set of tasks ordered by waiting time.

In other embodiment, the external pairing system 395 may be in a “stateful” environment, where the task assignment system 300 provides event information over the interface 385 such that the external pairing system 395 may maintain a mirror image of the state of the task assignment system 300. In other words, every relevant event that takes place in task assignment system 300 is shared with the external pairing system 395, such as time of arrival of every task, when an agent becomes available, when an agent logs out, when a call hangs up (in the context of a call center), etc. The interface 385 may support error-checking or reset functionality to help the external pairing system 395 maintain fidelity in the mirrored state with the task assignment system 300.

The task assignment system 300 is illustrated as having a single queue with the single switch 380 for simplicity. The task assignment system 300 could include additional queues with corresponding switches, in which case, either each switch could be communicatively coupled to the internal pairing system 390 and the external pairing system 395, or there could an internal pairing system and an external pairing system for each switch.

Notably, the present disclosure provides for embodiments of a task assignment system 300 that do not require a load balancer (not shown), although the present disclosure contemplates that a load balancer may be used in several implementations to route tasks to the switch 380 (and to the one or more PBX or ACD routing components of the switch 380). By using non-looping requests and/or tasks statuses, the non-looping task assignment system has a lower complexity, processing power, and memory constraint per task than conventional task assignment systems. Accordingly, the disclosed task assignment system 300 requires less need for complex load balancing layers to manage task volume, as required by conventional ACDs.

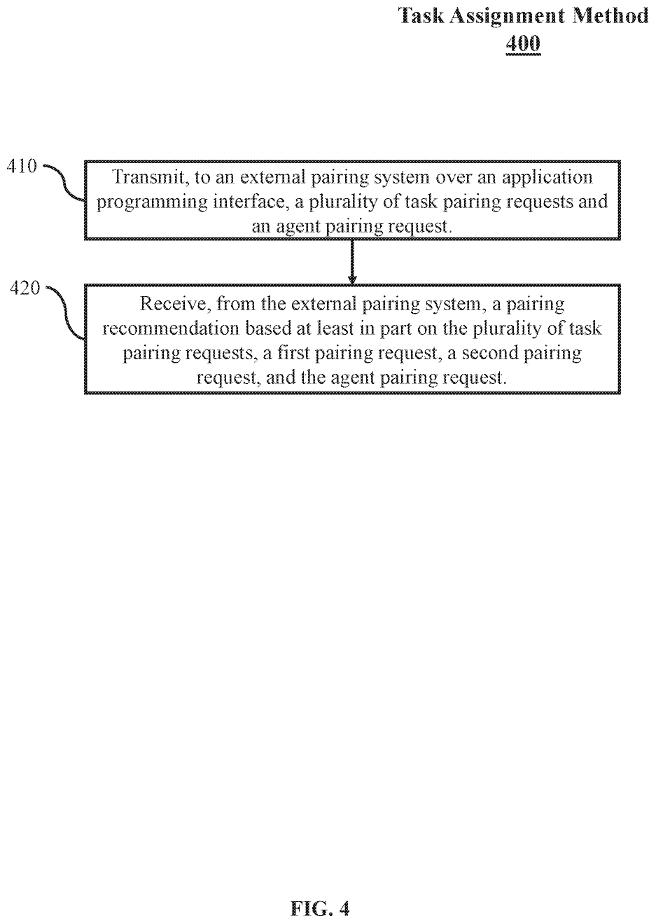

FIG. 4 shows a flow diagram of a task assignment method 400 for a task assignment system (e.g., task assignment system 300) with an external pairing system (e.g., external pairing system 395) according to embodiments of the present disclosure.

The task assignment method 400 may begin at block 410. At block 410, a plurality of task pairing requests and an agent pairing request may be transmitted to the external pairing system over an API. As described above, the plurality of task pairing requests may be generated based on pending tasks (e.g., task(s) 320). As described above, the plurality of task pairing requests may be received at the switch 380. The agent pairing request may be generated based on an available agent (e.g., agent(s) 330). As described above, available agents may also be received at switch 380.

At block 420, a pairing recommendation, that is based at least in part on the plurality of task pairing requests and the agent pairing request, may be received from the external pairing system. The pairing recommendation may pair the agent pairing request of available agent 330 to any one of the plurality of task pairing requests related to the pending tasks 330.

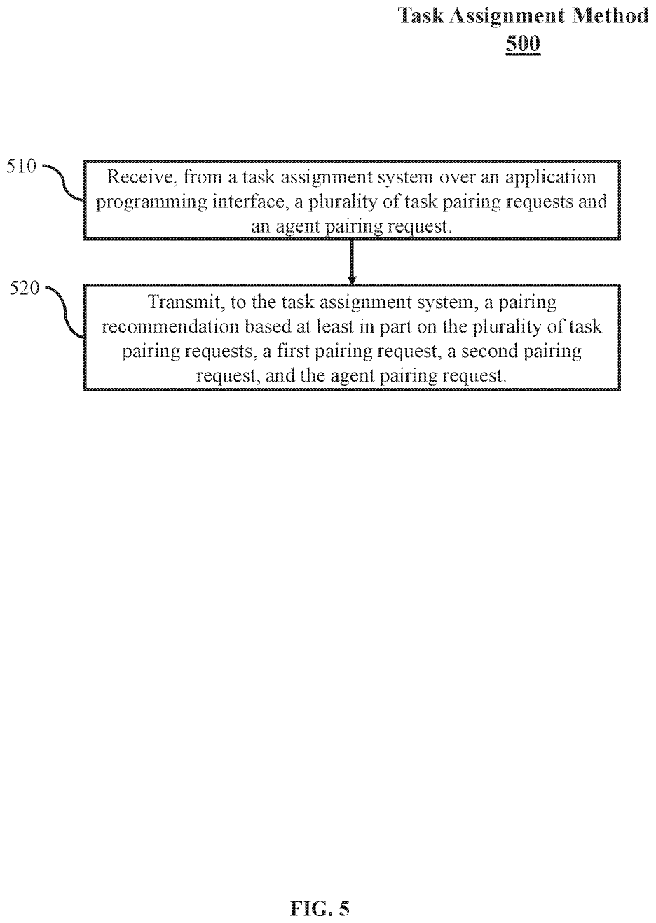

FIG. 5 shows a flow diagram of a task assignment method 500 for an external pairing system (e.g., external pairing system 395) communicatively coupled to a task assignment system (e.g., task assignment system 300) according to embodiments of the present disclosure.

The task assignment method 500 may begin at block 510. At block 510, a plurality of task pairing requests and an agent pairing request may be received from the task assignment system over an API. As described above, the plurality of task pairing requests may be generated based on pending tasks (e.g., task(s) 320). As described above, the plurality of task pairing requests may be received at the switch 380. The agent pairing request may be generated based on an available agent (e.g., agent(s) 330). As described above, available agents may also be received at switch 380.

At block 520, a pairing recommendation, that is based at least in part on the plurality of task pairing requests and the agent pairing request, may be transmitted to the task assignment system. The pairing recommendation may pair the agent pairing request of available agent 330 to any one of the plurality of task pairing requests related to the pending tasks 330.

At this point it should be noted that task assignment in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with task assignment in accordance with the present disclosure as described above. Alternatively, one or more processors operating in accordance with instructions may implement the functions associated with task assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

1. A method for determining a pairing in a task assignment system, comprising:
determining, by at least one computer processor communicatively coupled to and configured to operate in the task assignment system, that a set of one or more tasks is available for pairing with a set of one or more available agents;
generating, by the at least one computer processor, a pairing request based on the determining;
transmitting, by the at least one computer processor, over an application programming interface, the pairing request to an external pairing system;
receiving, by the at least one computer processor, over the application programming interface, a pairing response from the external pairing system based on the pairing request; and
connecting, by the at least one computer processor, a set of pairings among the set of tasks and the set of agents based on the pairing response,
wherein the pairing request includes information that determines a time-based ordering of the set of agents.

2. The method of claim 1, wherein the pairing request includes information that determines a time-based ordering of the tasks.

3. The method of claim 1, wherein the task assignment system is a contact center system.

4. The method of claim 1, wherein the pairing request identifies the set of one or more tasks and the set of one or more available agents.

5. The method of claim 1, wherein the pairing request is a non-looping request.

6. A system for determining a pairing in a task assignment system, comprising:
at least one computer processor communicatively coupled to and configured to operate in the task assignment system, wherein the at least one computer processor is further configured to:
determine that a set of one or more tasks is available for pairing with a set of one or more available agents;
generate a pairing request based on the determining;
transmit, over an application programming interface, the pairing request to an external pairing system;
receive, over the application programming interface, a pairing response from the external pairing system based on the pairing request; and
connect a set of pairings among the set of tasks and the set of agents based on the pairing response,
wherein the pairing request includes information that determines a time-based ordering of the set of agents.

7. The system of claim 6, wherein the pairing request includes information that determines a time-based ordering of the tasks.

8. The system of claim 6, wherein the task assignment system is a contact center system.

9. The system of claim 6, wherein the pairing request identifies the set of one or more tasks and the set of one or more available agents.

10. The system of claim 6, wherein the pairing request is a non-looping request.

11. An article of manufacture for determining a pairing in a task assignment system, comprising:
a non-transitory processor readable medium; and
instructions stored on the medium;
wherein the instructions are configured to be readable from the medium by at least one computer processor communicatively coupled to and configured to operate in the task assignment system and thereby cause the at least one computer processor to operate so as to:
determine that a set of one or more tasks is available for pairing with a set of one or more available agents;
generate a pairing request based on the determining;
transmit, over an application programming interface, the pairing request to an external pairing system;
receive, over the application programming interface, a pairing response from the external pairing system based on the pairing request; and
connect a set of pairings among the set of tasks and the set of agents based on the pairing response,
wherein the pairing request includes information that determines a time-based ordering of the set of agents.

12. The article of manufacture of claim 11, wherein the pairing request includes information that determines a time-based ordering of the tasks.

13. The article of manufacture of claim 11, wherein the task assignment system is a contact center system.

14. The article of manufacture of claim 11, wherein the pairing request identifies the set of one or more tasks and the set of one or more available agents.

15. The article of manufacture of claim 11, wherein the pairing request is a non-looping request.

16. A method for determining a pairing in a task assignment system, comprising:
determining, by at least one computer processor communicatively coupled to and configured to operate in the task assignment system, that a set of one or more tasks is available for pairing with a set of one or more available agents;
generating, by the at least one computer processor, a pairing request based on the determining;
transmitting, by the at least one computer processor, over an application programming interface, the pairing request to an external pairing system;
receiving, by the at least one computer processor, over the application programming interface, a pairing response from the external pairing system based on the pairing request; and
connecting, by the at least one computer processor, a set of pairings among the set of tasks and the set of agents based on the pairing response,
wherein the pairing request includes information that determines a time-based ordering of the set of tasks.

17. The method of claim 16, wherein the pairing request includes information that determines a time-based ordering of the agents.

18. The method of claim 16, wherein the task assignment system is a contact center system.

19. The method of claim 16, wherein the pairing request identifies the set of one or more tasks and the set of one or more available agents.

20. The method of claim 16, wherein the pairing request is a non-looping request.

21. A system for determining a pairing in a task assignment system, comprising:
at least one computer processor communicatively coupled to and configured to operate in the task assignment system, wherein the at least one computer processor is further configured to:
determine that a set of one or more tasks is available for pairing with a set of one or more available agents;
generate a pairing request based on the determining;
transmit, over an application programming interface, the pairing request to an external pairing system;
receive, over the application programming interface, a pairing response from the external pairing system based on the pairing request; and
connect a set of pairings among the set of tasks and the set of agents based on the pairing response,
wherein the pairing request includes information that determines a time-based ordering of the set of tasks.

22. The system of claim 21, wherein the pairing request includes information that determines a time-based ordering of the agents.

23. The system of claim 21, wherein the task assignment system is a contact center system.

24. The system of claim 21, wherein the pairing request identifies the set of one or more tasks and the set of one or more available agents.

25. The system of claim 21, wherein the pairing request is a non-looping request.

26. An article of manufacture for determining a pairing in a task assignment system, comprising:
a non-transitory processor readable medium; and
instructions stored on the medium;
wherein the instructions are configured to be readable from the medium by at least one computer processor communicatively coupled to and configured to operate in the task assignment system and thereby cause the at least one computer processor to operate so as to:
determine that a set of one or more tasks is available for pairing with a set of one or more available agents;
generate a pairing request based on the determining;
transmit, over an application programming interface, the pairing request to an external pairing system;
receive, over the application programming interface, a pairing response from the external pairing system based on the pairing request; and
connect a set of pairings among the set of tasks and the set of agents based on the pairing response,
wherein the pairing request includes information that determines a time-based ordering of the set of tasks.

27. The article of manufacture of claim 26, wherein the pairing request includes information that determines a time-based ordering of the agents.

28. The article of manufacture of claim 26, wherein the task assignment system is a contact center system.

29. The article of manufacture of claim 26, wherein the pairing request identifies the set of one or more tasks and the set of one or more available agents.

30. The article of manufacture of claim 26, wherein the pairing request is a non-looping request.

31. A method for determining a pairing in a task assignment system, comprising:
determining, by at least one computer processor communicatively coupled to and configured to operate in the task assignment system, that a task is available for pairing with a plurality of available agents;
generating, by the at least one computer processor, a pairing request based on the determining;
transmitting, by the at least one computer processor, over an application programming interface, the pairing request to an external pairing system;
receiving, by the at least one computer processor, over the application programming interface, a pairing response from the external pairing system based on the pairing request; and
connecting, by the at least one computer processor, the task to an agent of the plurality of agents based on the pairing response,
wherein the pairing request includes information that determines a time-based ordering of the plurality of agents.

32. The method of claim 31, wherein the external pairing system maintains a mirror image of a state of the task assignment system.

33. The method of claim 31, wherein the task assignment system is a contact center system.

34. The method of claim 31, wherein the pairing request identifies the task and the plurality of available agents.

35. The method of claim 31, wherein the pairing request is a non-looping request.

36. A system for determining a pairing in a task assignment system, comprising:
at least one computer processor communicatively coupled to and configured to operate in the task assignment system, wherein the at least one computer processor is further configured to:
determine that a task is available for pairing with a plurality of available agents;
generate a pairing request based on the determining;
transmit, over an application programming interface, the pairing request to an external pairing system;
receive, over the application programming interface, a pairing response from the external pairing system based on the pairing request; and
connect the task to an agent of the plurality of agents based on the pairing response,
wherein the pairing request includes information that determines a time-based ordering of the plurality of agents.

37. The system of claim 36, wherein the external pairing system maintains a mirror image of a state of the task assignment system.

38. The system of claim 36, wherein the task assignment system is a contact center system.

39. The system of claim 36, wherein the pairing request identifies the task and the plurality of available agents.

40. The system of claim 36, wherein the pairing request is a non-looping request.

41. An article of manufacture for determining a pairing in a task assignment system, comprising:
a non-transitory processor readable medium; and
instructions stored on the medium;
wherein the instructions are configured to be readable from the medium by at least one computer processor communicatively coupled to and configured to operate in the task assignment system and thereby cause the at least one computer processor to operate so as to:
determine that a task is available for pairing with a plurality of available agents;
generate a pairing request based on the determining;
transmit, over an application programming interface, the pairing request to an external pairing system;
receive, over the application programming interface, a pairing response from the external pairing system based on the pairing request; and
connect the task to an agent of the plurality of agents based on the pairing response,
wherein the pairing request includes information that determines a time-based ordering of the plurality of agents.

42. The article of manufacture of claim 41, wherein the external pairing system maintains a mirror image of a state of the task assignment system.

43. The article of manufacture of claim 41, wherein the task assignment system is a contact center system.

44. The article of manufacture of claim 41, wherein the pairing request identifies the task and the plurality of available agents.

45. The article of manufacture of claim 41, wherein the pairing request is a non-looping request.

46. A method for determining a pairing in a task assignment system, comprising:
determining, by at least one computer processor communicatively coupled to and configured to operate in the task assignment system, that a plurality of tasks is available for pairing with an available agent;
generating, by the at least one computer processor, a pairing request based on the determining;
transmitting, by the at least one computer processor, over an application programming interface, the pairing request to an external pairing system;
receiving, by the at least one computer processor, over the application programming interface, a pairing response from the external pairing system based on the pairing request; and
connecting, by the at least one computer processor, the available agent to a task of the plurality of tasks based on the pairing response,
wherein the pairing request includes information that determines a time-based ordering of the plurality of tasks.

47. The method of claim 46, wherein the external pairing system maintains a mirror image of a state of the task assignment system.

48. The method of claim 46, wherein the task assignment system is a contact center system.

49. The method of claim 46, wherein the pairing request identifies the task and the plurality of available agents.

50. The method of claim 46, wherein the pairing request is a non-looping request.

51. A system for determining a pairing in a task assignment system, comprising:
at least one computer processor communicatively coupled to and configured to operate in the task assignment system, wherein the at least one computer processor is further configured to:
determine that a plurality of tasks is available for pairing with an available agent;
generate a pairing request based on the determining;
transmit, over an application programming interface, the pairing request to an external pairing system;
receive, over the application programming interface, a pairing response from the external pairing system based on the pairing request; and
connect the available agent to a task of the plurality of tasks based on the pairing response,
wherein the pairing request includes information that determines a time-based ordering of the plurality of tasks.

52. The system of claim 51, wherein the external pairing system maintains a mirror image of a state of the task assignment system.

53. The system of claim 51, wherein the task assignment system is a contact center system.

54. The system of claim 51, wherein the pairing request identifies the task and the plurality of available agents.

55. The system of claim 51, wherein the pairing request is a non-looping request.

56. An article of manufacture for determining a pairing in a task assignment system, comprising:
a non-transitory processor readable medium; and
instructions stored on the medium;
wherein the instructions are configured to be readable from the medium by at least one computer processor communicatively coupled to and configured to operate in the task assignment system and thereby cause the at least one computer processor to operate so as to:
determine that a plurality of tasks is available for pairing with an available agent;
generate a pairing request based on the determining;
transmit, over an application programming interface, the pairing request to an external pairing system;
receive, over the application programming interface, a pairing response from the external pairing system based on the pairing request; and
connect the available agent to a task of the plurality of tasks based on the pairing response,
wherein the pairing request includes information that determines a time-based ordering of the plurality of tasks.

57. The article of manufacture of claim 56, wherein the external pairing system maintains a mirror image of a state of the task assignment system.

58. The article of manufacture of claim 56, wherein the task assignment system is a contact center system.

59. The article of manufacture of claim 56, wherein the pairing request identifies the task and the plurality of available agents.

60. The article of manufacture of claim 56, wherein the pairing request is a non-looping request.
